(19) United States
(12) Patent Application Publication
(10) Pub. No.: US 2026/0219482 A1
(43) Pub. Date: Jul. 30, 2026

(54) CONTROL APPARATUS, OPTICAL APPARATUS, CONTROL METHOD, AND STORAGE MEDIUM

(71) Applicant: CANON KABUSHIKI KAISHA, Tokyo (JP)

(72) Inventor: Ryota SEKIMOTO, Tokyo (JP)

(21) Appl. No.: 19/422,562

(22) Filed: Dec. 17, 2025

(30) Foreign Application Priority Data
Jan. 28, 2025 (JP) 2025-011969

(51) Int. Cl. G02B 15/16; G02B 7/10; G02B 15/14; H04N 23/69

(52) U.S. Cl. CPC G02B 15/16; G02B 7/102; G02B 15/142; H04N 23/69

(57) ABSTRACT

A control apparatus is configured to control movements of a first optical element and a second optical element in an optical axis direction. The control apparatus includes one or more memories storing instructions, and one or more processors that, upon execution of the instructions, operate to acquire information on a reference position of the first optical element at each of a plurality of first reference positions, at least one of the plurality of first reference positions being located within a movable range of the second optical element, and in a specific control for moving the first optical element for detecting the reference position and moving the second optical element to a predetermined position within the movable range, change a specific reference position among the plurality of first reference positions according to the predetermined position. The specific reference position is used for detecting the reference position.

### BACKGROUND

### Field of the Technology

The aspect of the disclosure relates to one or more embodiments of a control apparatus, an optical apparatus, such as an image pickup apparatus and a lens apparatus, a control method, and a storage medium.

### Description of the Related Art

Some optical apparatuses may perform reset control to move a lens to a reference position using a stepping motor, and detect the position of the lens by detecting a moving amount of the lens (stepping motor) from the reference position after the reset control. Other optical apparatuses may control the movement of each lens to avoid interference between the two lenses, in a case where there is an overlapping area in the movable ranges of the two lenses.

Japanese Patent Application Publication No. 2012-014094 discloses an optical apparatus in which two photo-interrupters configured to detect the reference positions of the two lenses are arranged on outside of the overlapping area in the movable ranges of these lenses. In this optical apparatus, in a case where it is determined that one lens is disposed in the overlapping area based on the signal from each photo-interrupter, the interference between the two lenses can be avoided by retracting that lens to the outside of the overlapping area before the reset control of the other lens is performed.

### SUMMARY

One or more embodiments of a control apparatus according to one aspect of the disclosure configured to control movements of a first optical element and a second optical element in an optical axis direction may include one or more memories storing instructions, and one or more processors that, upon execution of the instructions, operate to acquire information on a reference position of the first optical element at each of a plurality of first reference positions, at least one of the plurality of first reference positions being located within a movable range of the second optical element, and in a specific control for moving the first optical element for detecting the reference position and moving the second optical element to a predetermined position within the movable range, change a specific reference position among the plurality of first reference positions according to the predetermined position. The specific reference position is used for the detecting. Alternatively, the one or more processors may operate to set, in a specific control for moving the first optical element for detecting the reference position and moving the second optical element to a predetermined position within the movable range, a specific reference position among the plurality of first reference positions to a first reference position located outside a movement path of the second optical element to the predetermined position. The optical apparatus having the above control method also constitutes another aspect of the disclosure. One or more control methods corresponding to each of the above control method also constitute another aspect of the disclosure. A storage medium storing a program that causes a computer to execute the above control method also constitutes another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating the configuration of a camera system according to the embodiment.

FIGS. 2A, 2B, 2C, 2D, and 2E illustrate a reference position detector in the embodiment.

FIGS. 3A and 3B illustrate reset controls in the conventional system and the embodiment.

FIG. 4 is a flowchart illustrating reset control processing of a focus lens in the embodiment.

FIG. 5 is a flowchart illustrating the reset control processing of a zoom lens in the embodiment.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a description will be given of embodiments according to the disclosure.

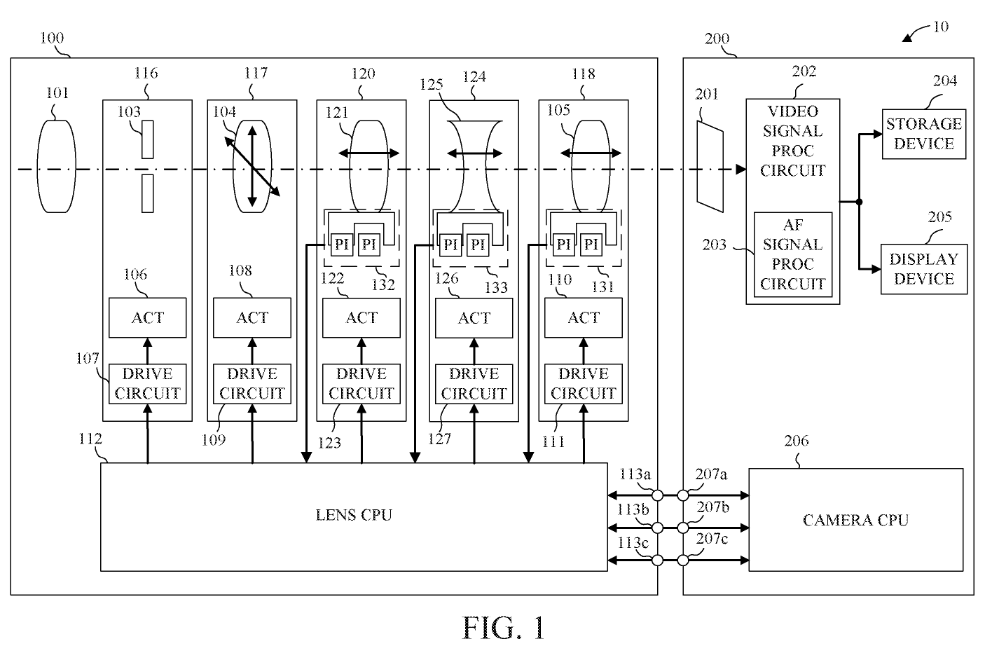

FIG. 1 illustrates the configuration of the camera system 10 according to this embodiment. The camera system 10 includes a lens apparatus (optical apparatus: referred to as an interchangeable lens hereinafter) 100 and an image pickup apparatus (hereinafter referred to as a camera body) 200 to which the interchangeable lens 100 is detachably and communicably attached. In this embodiment, an interchangeable lens is an optical apparatus, but the optical apparatus may also be a lens integrated type image pickup apparatus.

The camera body 200 includes an image sensor 201 as a photoelectric conversion element, such as a CCD sensor or a CMOS sensor. The image sensor 201 photoelectrically converts an optical image (object image) formed on its imaging surface by an imaging optical system described later. The image sensor 201 outputs an analog imaging signal generated from the photoelectric conversion to a video signal processing circuit 202.

The video signal processing circuit 202 converts the analog imaging signal from the image sensor 201 into a digital imaging signal, and performs various signal processing, such as amplification and gamma correction, on the digital imaging signal to generate a video signal. The video signal is output to a camera CPU 206, a display device 205 such as a liquid crystal panel, and a storage device 204 such as an optical disc or semiconductor memory.

The video signal processing circuit 202 also includes an autofocus (AF) signal processing circuit 203. The AF signal processing circuit 203 extracts high-frequency components and luminance components obtained from a group of pixels in the AF area, which is a focus detecting area, from the digital imaging signal or video signal to generate a focus evaluation value signal as focus information. The focus evaluation value signal indicates the contrast state of the image (imaging contrast), that is, the sharpness, and changes with the movement of the focus lens 105. The position of the focus lens 105, where the value of the focus evaluation signal, that is, the focus evaluation value, is maximum (peak), is a focus position in that AF area.

The camera CPU 206 controls the operation of the camera body 200 and also controls the operation of the interchangeable lens 100 while communicating with a lens CPU 112 in the interchangeable lens 100. When the interchangeable lens 100 is attached to the camera body 200, electrical contacts 207a, 207b, and 207c provided on the camera body 200 are connected to electrical contacts 113a, 113b, and 113c provided on the interchangeable lens 100, respectively. This enables communication between the camera CPU 206 and the lens CPU 112. In FIG. 1, the camera CPU 206 and the lens CPU 112 communicate using a 3-wire serial communication method, but other communication methods may also be used. In this embodiment, serial communication is performed with the camera CPU 206 as the clock master.

Each of the interchangeable lens 100 and the camera body 200 includes one or more memories (not illustrated) storing instructions. In this embodiment, the lens CPU 112 corresponds to one or more processors that, upon execution of the instructions, operate to acquire information on a reference position of the focus lens 105 at each of a plurality of first reference positions, and control movements of the focus lens 105 and the zoom lens 125. More specifically, the lens CPU 112 operate to change, in a specific control for moving the focus lens 105 for detecting the reference position and moving the zoom lens 125 to a predetermined position within the movable range, a used reference position (specific reference position) for detecting the reference position among the plurality of first reference positions according to the predetermined position. In a lens integrated type image pickup apparatus, the camera CPU 206 corresponds to the above one or more processors. The one or more memories and the one or more processors constitute a control apparatus.

Power supply contacts (not illustrated) provided on the camera body 200 are connected to power supply contacts (not illustrated) provided on the interchangeable lens 100. This allows power from a battery (not illustrated), such as a lithium-ion battery, mounted on the camera body 200 to be supplied to the interchangeable lens 100 via a power supply circuit such as a DC-DC converter.

In the interchangeable lens 100, the imaging optical system includes a fixed front lens 101, an aperture stop 103, a correction lens 104, a focus lens 105, a floating lens 121, and a zoom lens 125. Each lens includes one or more lens elements. The focus lens 105, the floating lens 121, and the zoom lens 125 are movable along the optical axis of the imaging optical system (i.e., coaxially).

The aperture stop 103 is driven by an aperture actuator 106, such as a stepping motor or a DC motor, to change its aperture diameter. The aperture drive circuit 107 supplies drive voltage and current to the aperture actuator 106. The aperture stop 103, aperture actuator 106, and aperture drive circuit 107 constitute a light amount adjustment apparatus 116.

The correction lens 104 is driven by a correction actuator 108, such as a stepping motor or a voice coil motor, and moves in a plane orthogonal to the optical axis of the imaging optical system to correct image blur caused by camera shake, such as hand shake. A correction drive circuit 109 supplies drive voltage and current to the correction actuator 108. The correction lens 104, correction actuator 108, and correction drive circuit 109 constitute a correction apparatus 117.

The focus lens 105 is driven by a focus actuator 110, such as a stepping motor, and moves in the direction of the optical axis (optical axis direction) of the imaging optical system to perform focusing. The focus drive circuit 111 supplies drive voltage and current to the focus actuator 110. A focusing apparatus 118 includes the focus lens 105, focus actuator 110, and focus drive circuit 111.

The floating lens 121 is driven by a floating actuator 122, such as a stepping motor, and moves in the optical axis direction to perform aberration correction and focusing. A floating drive circuit 123 supplies drive voltage and current to the floating actuator 122. The floating lens 121, floating actuator 122, and floating drive circuit 123 constitute the floating apparatus 120.

The zoom lens 125 is driven by a zoom actuator, such as a stepping motor, and moves in the optical axis direction to change a magnification. Changing the distance between adjacent lenses can vary the magnification between the wide-angle end and the telephoto end. A zoom drive circuit 127 supplies drive voltage and current to the zoom actuator 126. The zoom lens 125, zoom actuator 126, and zoom drive circuit 127 constitute the zoom apparatus 124.

The drive method for each of the aperture actuator 106, correction actuator 108, focus actuator 110, floating actuator 122, and zoom actuator 126 may be a PWM drive method. In this case, the lens CPU 112 transmits a drive signal to each drive circuit to specify the PWM duty cycle, and each drive circuit drives each actuator with a duty cycle corresponding to the received drive signal.

Next follows a description of a reset control as a specific control when each of the focus lens 105, floating lens 121, and zoom lens 125 is driven with a stepping motor. The reset control is a control that moves each lens to a reference position for detecting its position, and in this embodiment, it further includes a control to move from the reference position to a predetermined position described later.

The focus reference position detector 131 detects when the focus lens 105 is at the focus reference position, the floating reference position detector 132 detects when the floating lens 121 is at the floating reference position, and the zoom reference position detector 133 detects when the zoom lens 125 is at the zoom reference position.

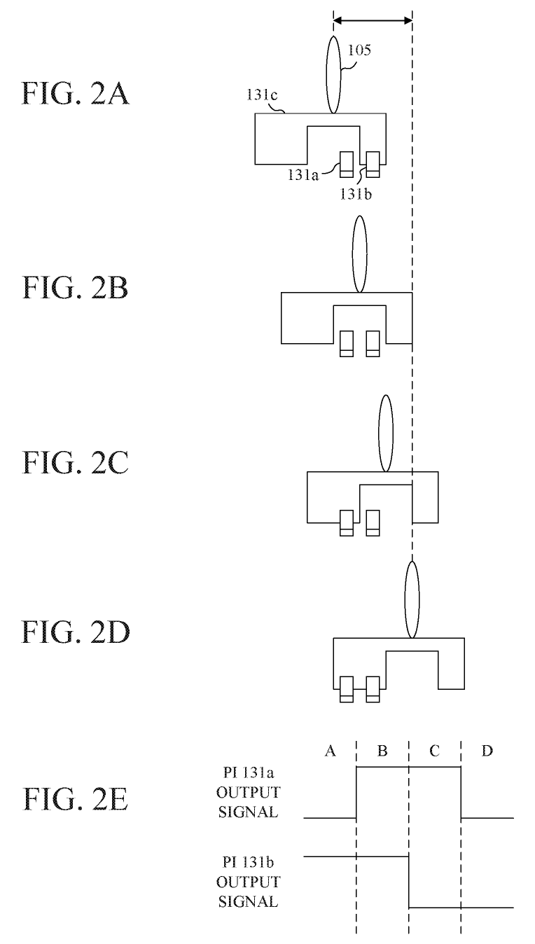

FIGS. 2A, 2B, 2C, 2D, and 2E illustrate the focus reference position detector 131. A first photo-interrupter (PI) 131a allows a focus light-shielding plate 131c to pass between its light emitter and light receiver. The focus light-shielding plate 131c moves integrally with the focus lens 105 in the optical axis direction. The output signal from the light receiver of the first PI 131a changes between a high level and a low level according to whether or not the focus light-shielding plate 131c is disposed between the light emitter and the light receiver. This change allows for the detection of whether or not the focus lens 105 is disposed at the focus reference position.

While it is possible to detect whether or not the focus lens 105 is disposed at the focus reference position using the single first PI 131a, in this embodiment, a second PI 131b is also used to reduce the time for reset control (referred to as reset time hereinafter).

FIGS. 2A, 2B, 2C, and 2D illustrate a positional relationship between the focus light-shielding plate 131c and the first and second PIs 131a and 131b. FIG. 2E illustrates a combination of output signals from the first and second PIs 131a and 131b when the focus light-shielding plate 131c is in the positions illustrated in FIGS. 2A, 2B, 2C,and 2D, indicated by A, B, C, and D.

The lens CPU 112 detects that the focus lens 105 is disposed at the focus reference position when the combination of output signals from the first and second PIs 131a and 131b becomes D. Then, it detects the position of the focus lens 105 by counting the drive amount (number of drive pulses) of the stepping motor that drives the focus lens 105.

The reset control may be performed as quickly as possible to reduce the reset time. However, to accurately detect the reference position, the stepping motor may be reversely driven after the focus lens 105 has passed the reference position, and move the focus lens 105 back to the reference position at a speed lower than the normal speed when the focus lens 105 passes the reference position.

As illustrated in FIG. 2E, there are four combinations of output signals from the first and second PI 131a and 131b: A, B, C, and D. The lens CPU 112 can detect the position (zone) of the focus lens 105 relative to the focus reference position based on which of these four combinations the output signals from the first and second PI 131a and 131b correspond to.

In the reset control, there are a total of three points where the output signals of the first and second PI 131a and 131b, which can serve as the focus reference position, change. To reduce the reset time, it is desirable to first detect which zone among A to D the current focus lens 105 is located in, and then use the focus reference position that is closer to the current zone for reference position detection. After driving the focus lens 105 to the focus reference position (referred to as reference position drive hereinafter), the lens CPU 112 further drives the focus lens 105 to a predetermined position (referred to as predetermined position drive hereinafter). The predetermined position here is, for example, the original position before reset control or the infinity end. After the reference position drive and predetermined position drive of the focus lens 105 are completed, the reset control of the focus lens 105 is completed.

The floating reference position detector 132 and the zoom reference position detector 133 are configured similarly to the focus reference position detector 131 and output similar output signals. Thereby, the floating lens 121 and the zoom lens 125 are driven to their respective floating reference position and zoom reference position, and then driven to their predetermined positions to complete the reset control.

The problems of the reset control will be discussed. In a case where there is an overlapping area in the movable range of two of the focus lens 105, floating lens 121, and zoom lens 125, the two lenses may interfere (collide) with each other during their movement. In a case where such interference occurs, the position of each lens managed by the lens CPU 112 may be misaligned, or the stepping motor may lose synchronization (step out).

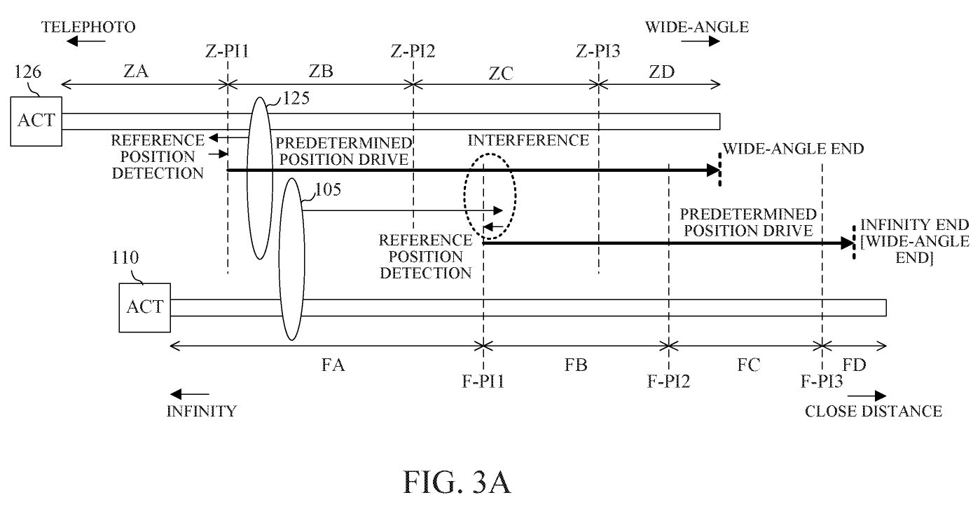

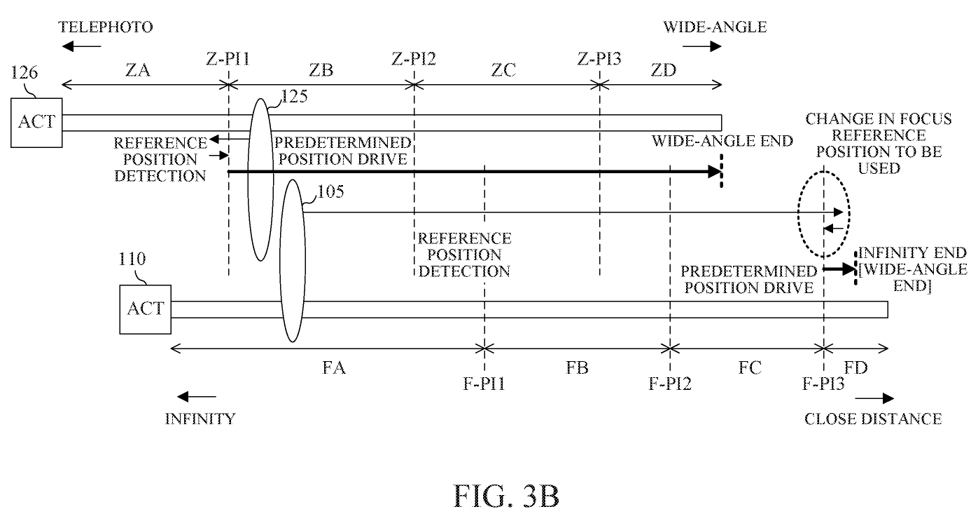

Referring now to FIG. 3A, a description will be given of the interference between the focus lens 105 and the zoom lens 125 in the reset control when there is an overlapping area in the movable range of the focus lens 105 as the first optical element and the zoom lens 125 as the second optical element. Here, it is assumed that the drive speeds (normal speeds) of the focus lens 105 and the zoom lens 125 are the same. In FIG. 3A, it is assumed that the focus lens 105 and the zoom lens 125 are currently located at the positions illustrated by the lens shapes in FIG. 3A. The wide-angle direction (direction toward the wide-angle end) of the zoom lens 125 and the close distance direction (direction toward the close distance end) of the focus lens 105 correspond to the first direction, and the telephoto direction (direction toward the telephoto end) of the zoom lens 125 and the infinity direction (direction toward the infinity end) of the focus lens 105 correspond to the second direction, which is opposite to the first direction. The focus lens 105 is disposed in the first direction from the zoom lens 125.

As illustrated in FIG. 3A, a part of the movable range of the focus lens 105 on the infinity side and a part of the movable range of the zoom lens 125 on the wide-angle side overlap, forming an overlapping region. There are a plurality of, i.e., three, focus reference positions (first reference positions) where the first and second PIs are disposed: F-PI1, F-PI2, and F-PI3. Thereby, the movable range of the focus lens 105 can be divided into four zones: FA, FB, FC, and FD. Similarly, there are a plurality of, i.e., three, zoom reference positions (second reference positions) where the first and second PIs are disposed: Z-PI1, Z-PI2, and Z-PI3. Thereby, the movable range of the zoom lens 125 can be divided into four zones: ZA, ZB, ZC, and ZD. The focus reference positions F-PI1 and F-PI2 are located within the movable range of the zoom lens 125, while the focus reference position F-PI3 is located outside the movable range of the zoom lens 125 in the wide-angle direction.

First, the interference between the focus lens 105 and the zoom lens 125 during the reference position drive will be discussed. At the start of the reference position drive, the lens CPU 112 cannot recognize the exact positions of the focus lens 105 and the zoom lens 125. To avoid interference between the focus lens 105 and the zoom lens 125 in this state, the focus lens 105 and the zoom lens 125 may be moved in opposite directions. More specifically, the reference position drive is performed to move the focus lens 105 to the closest focus reference position (e.g., F-PI1) on the close distance side of the zone in which the focus lens 105 is currently located, and to move the zoom lens 125 to the closest zoom reference position (e.g., Z-PI1) on the telephoto side of the zone in which the zoom lens 125 is currently located.

This does not apply in a case where the focus lens 105 is currently located in the FD zone closest to the close distance end or the zoom lens 125 is currently located in the ZA zone closest to the telephoto side. In these cases, the focus lens 105 and the zoom lens 125 are moved to the focus reference position and zoom reference position, respectively, closest to the infinity end and wide-angle end of their current zones. At this time, the drive directions of the focus lens 105 and the zoom lens 125 will not be opposite to each other, but since they are far apart, they will not interfere with each other.

Next, the interference between the focus lens 105 and the zoom lens 125 during the predetermined position drive will be discussed. In a case where the predetermined position of each lens is the original position before the reset control (reference position drive), the focus lens 105 and the zoom lens 125 will not interfere with each other. More precisely, as described later, in a case where the focus lens 105 and the zoom lens 125 perform predetermined position drive after waiting for the completion of their reference position drive, they will not interfere with each other.

On the other hand, if the movement destination in the predetermined position drive of the zoom lens 125 is the wide-angle end, and the predetermined position of the focus lens 105 is the infinity end at the wide-angle end (referred to as infinity end [wide-angle end] hereinafter), interference may occur between the focus lens 105 and the zoom lens 125. The infinity end of the focus lens 105 changes according to the position of the zoom lens 125 (focal length of the imaging optical system). Therefore, the position of the wide-angle end of the zoom lens 125 and the position of the infinity end [wide-angle end] of the focus lens 105 are the positions indicated by thick broken lines in FIG. 3A. In a case where the initial positions of the focus lens 105 and the zoom lens 125 are these positions, reference position drive is performed to move the zoom lens 125 to the zoom reference position Z-PI1, and then predetermined position drive is performed to the original initial position. At this time, the reference position drive is performed to move the focus lens 105 to the focus reference position F-PI1. A distance from the initial position of the focus lens 105 to the focus reference position F-PI1 is greater than a distance from the initial position of the zoom lens 125 to the zoom reference position Z-PI1. Therefore, reference position drive of the focus lens 105 has not been completed when reference position drive of the zoom lens 125 (start of predetermined position drive) is completed. As a result, interference may occur between the focus lens 105, which is being driven at a low speed around the focus reference position F-PI1, and the zoom lens 125, which is undergoing predetermined position drive. That is, if there is an overlapping area in the movable range of the two lenses, and the reference position of one lens is located within the movement path of the other lens during the predetermined position drive, interference may occur depending on the initial positions of the two lenses.

Although interference between these lenses can be avoided by performing a control that waits for the completion of the reference position drive of the focus lens 105 before the predetermined position drive of the zoom lens 125 starts after the reference position drive is completed, this would increase the reset time. Therefore, the following control may be performed.

FIG. 3B illustrates a reset control that avoids interference between the focus lens 105 and the zoom lens 125 while reducing the reset time. The reason for the above interference is that the focus lens 105 uses the focus reference position F-PI1, which is on the movement path of the zoom lens 125 during the predetermined position drive, to detect the reference position. Therefore, to avoid this interference, the focus reference position as the used reference position for detecting the reference position of the focus lens 105 may be changed according to the predetermined position to which the zoom lens 125 is moved. That is, a different focus reference position may be set as the used reference position according to the predetermined position to which the zoom lens 125 is moved. More specifically, a focus reference position located outside the movement path of the zoom lens 125 to the predetermined position may be set as the used reference position.

More specifically, at the start of the reset control, the predetermined positions to which the zoom lens 125 and the focus lens 102 are moved by the predetermined position drive are determined. In a case where the predetermined positions are the wide-angle end and the infinity end [wide-angle end], respectively, the focus reference position F-PI3 is used to detect the reference position of the focus lens 105. In this case, the zoom lens 125 moves in the wide-angle direction during the predetermined position drive, but the focus reference position F-PI1 is located closer to the wide-angle end, which is the movement destination of the zoom lens 125, while the focus reference position F-PI3 is located further away. Therefore, in a case where the focus reference position F-PI1 is used for detecting the reference position of the focus lens 105, interference may occur between the focus lens 105 and the zoom lens 125 during predetermined position drive, whereas using the focus reference position F-PI3 can avoid such interference.

In this reset control, the focus lens 105 is driven from its initial position in the close distance direction, and after the reference position is detected along the way, it reaches the predetermined position, which is the infinity end [wide-angle end]. The focus reference position F-PI3 that is used to avoid interference is located closer than the infinity end [wide-angle end], which is the movement destination of the focus lens 105 in driving in the close distance direction. That is, using a focus reference position that is on the way to the final movement destination, the infinity end [wide-angle end], for reference position detection does not increase the reset time.

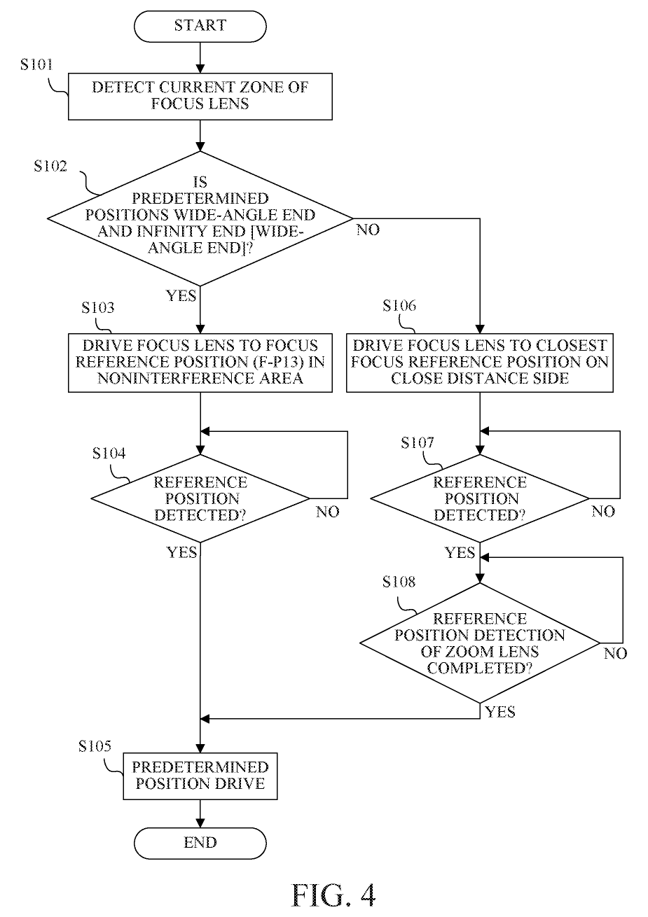

A flowchart in FIG. 4 illustrates reset control processing(control method) of the focus lens 105. The lens CPU (control unit) 112, as a computer, executes this processing according to the computer program.

In step S101, the lens CPU 112 detects a zone in which the focus lens 105 is currently located based on a signal output from the focus reference position detector 131 as a first detector. As discussed above, the zone in which the focus lens 105 is located can be detected from the combination of the output signals of the first and second PIs 131a and 131b.

Next, in step S102, the lens CPU 112 determines whether the predetermined positions, which are the final movement destinations in the reset control of the zoom lens 125 and the focus lens 105, are the wide-angle end and the infinity end [wide-angle end], respectively. The predetermined position varies according to the timing at which the reset control is performed. The timing at which the reset control is performed includes, for example, when the interchangeable lens 100 is attached to the camera body 200, when the camera body 200 switches from a power-off state to a power-on state, and when the focus lens 105 recovers from a step-out state.

The lens CPU 112 detects which timing the reset control to be executed will be executed, and determines the predetermined position at that detected timing. Here, the predetermined positions of the zoom lens 125 and the focus lens 105 are assumed to be the wide-angle end and the infinity end [wide-angle end], respectively. However, other predetermined positions may also be used. Thus, in step S102, it is determined whether the predetermined positions cause interference during the predetermined position drive of the zoom lens 125 and the focus lens 105. In a case where the predetermined positions are the wide-angle end and the infinity end [wide-angle end], the processing of step S103 is performed; otherwise, the processing of step S106 is performed.

In step S103, the lens CPU 112 moves the focus lens 105 toward a focus reference position in a noninterference area in which no interference with the zoom lens 125 occurs. Here, the noninterference area is an area from the initial position of the zoom lens 125 before the reset control to the predetermined position (wide-angle end) after the reset control of the zoom lens 125. In other words, it is the area outside the movement path from the initial position to the predetermined position of the zoom lens 125. Detecting the reference position of the focus lens 105 using a focus reference position in the noninterference area can avoid interference between the focus lens 105 and the zoom lens 125. Here, the focus reference position F-PI3 illustrated in FIG. 3B is a focus reference position located in the noninterference area.

Next, in step S104, the lens CPU 112 determines whether the focus lens 105 has reached the focus reference position, that is, whether the reference position has been detected, based on the signal output from the focus reference position detector 131. As discussed above, in order to accurately count the drive pulses of the stepping motor, it is also possible to determine whether the focus lens 105 has reached the focus reference position after it has once passed the focus reference position and then been reversely driven at a low speed. In a case where the focus lens 105 has reached the focus reference position, the processing of step S105 is performed; otherwise, the determination in step S104 is repeated (standby).

In step S105, the lens CPU 112 moves the focus lens 105 to a predetermined position. Then, this flow ends.

In step S106, the lens CPU 112 moves the focus lens 105 from its currently disposed zone detected in step S101 to the closest focus reference position in that close distance direction (e.g., F-PI1). The predetermined positions of the zoom lens 125 and focus lens 105 in step S106 are, for example, the original positions before the reset control. Waiting for the completion of these reference position detections (reference position drive) before the predetermined position drive is performed can avoid interference between them.

In a case where both the predetermined positions of the focus lens 105 and the zoom lens 125 are the original positions before the reset control, the reset time does not increase even if the completions of their reference position detections are waited for, for reasons described later. Therefore, the focus reference position used for detecting the reference position of the focus lens 105 can be the closest position from the current position in the close distance direction. Thus, if the predetermined position of the zoom lens 125 is inside the wide-angle end of the movable range of the zoom lens 125, the focus reference position within the movable range of the zoom lens 125 (especially the focus reference position closest to the focus lens 105) may be used for reference position detection. In a case where the predetermined position of the zoom lens 125 is located, for example, between the focus reference positions FP-1 and FP-2 (e.g., near the zoom reference position Z-PI3), the focus reference position FP-2 closest to the focus lens 105 in the close distance direction from that predetermined position may be used for detecting the reference position of the focus lens 105.

Next, in step S107, the lens CPU 112 determines whether the focus lens 105 has reached the focus reference position (i.e., whether the reference position has been detected) based on the signal output from the focus reference position detector 131. In a case where the focus lens 105 has reached the focus reference position, the flow proceeds to step S108; otherwise, the determination in step S107 is repeated (standby).

In step S108, the lens CPU 112 determines whether the reference position detection of the zoom lens 125 has been completed. This determination is made to avoid interference between the focus lens 105 and the zoom lens 125, by waiting until the reference position detection of the zoom lens 125 is completed before the focus lens 105 is driven to the predetermined position.

As discussed above, in a case where the predetermined positions of both the zoom lens 125 and the focus lens 105 are their original positions before the reset control, waiting until the completion of the reference position detection of each lens will not increase the reset time. This is because even if the reset time of one lens increases by the waiting time, it will not exceed the reset time of the other lens. In a case where the predetermined position is the original position, the longer the time from the start of reference position drive to the reference position detection, the longer the time required for driving to the predetermined position, and the reset time is the sum of these times. In this case, even if the other lens waits for the predetermined position drive, the predetermined position drive of the other lens after waiting will be completed first, so the reset time will not increase. Therefore, in a case where both the predetermined positions of the zoom lens 125 and the focus lens 105 are their original positions, waiting until the completions of their reference position detections may be used.

In a case where the reference position detection of the zoom lens 125 is completed, the flow proceeds to step S105; otherwise, the determination in step S108 is repeated (standby).

In the processing from step S108 to step S105, the focus lens 105 is stopped and its predetermined position drive is delayed until the reference position detection of the zoom lens 125 is completed, but the focus lens 105 may be driven to its predetermined position at a speed lower than the normal speed. In other words, the predetermined position drive of the focus lens 105 may be delayed by waiting or driving at a speed lower than the normal speed until the reference position detection of the zoom lens 125 is completed.

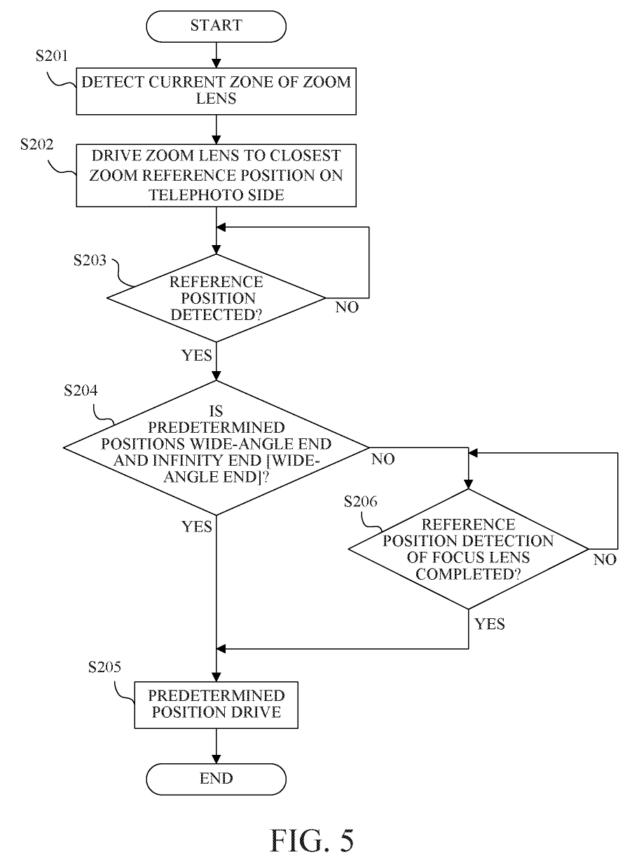

A flowchart in FIG. 5 illustrates the reset control processing for the zoom lens 125. The lens CPU 112 executes this processing according to the computer program.

In step S201, the lens CPU 112 detects a zone where the zoom lens 125 is currently located, based on a signal output from the zoom reference position detector 133 as a second detector.

Next, in step S202, the lens CPU 112 moves the zoom lens 125 from the current zone detected in step S201 towards the closest zoom reference position on the telephoto side.

Next, in step S203, the lens CPU 112 determines whether the zoom lens 125 has reached the zoom reference position (i.e., whether reference position has been detected) based on a signal output from the zoom reference position detector 133. In a case where the zoom lens 125 has reached the zoom reference position, the flow proceeds to step S204; otherwise, the determination in step S203 is repeated (standby).

In step S204, the lens CPU 112 determines whether the predetermined positions of the zoom lens 125 and the focus lens 105 are the wide-angle end and the infinity end [wide-angle end], respectively. Similarly to step S102, it determines whether the predetermined position is a position where interference occurs during predetermined position drive. The predetermined position is not limited to the wide-angle end and the infinity end [wide-angle end]. For the zoom lens 125, the zoom reference position (used reference position) used for reference position detection is not changed according to the predetermined position, but this determination is performed in order to perform waiting processing in the following step S206 to wait for the completions of reference position detections of the zoom lens 125 and the focus lens 105. In a case where the predetermined positions are the wide-angle end and the infinity end [wide-angle end], the flow proceeds to step S205; otherwise, the flow proceeds to step S206.

In step S205, the lens CPU 112 moves the zoom lens 125 to a predetermined position. Then, this flow ends.

On the other hand, in step S206, the lens CPU 112 determines whether the reference position detection of the focus lens 105 has been completed. As described above, this determination is made to avoid interference between the focus lens 105 and the zoom lens 125, and is a determination to wait until the reference position detection of the focus lens 105 is completed before the zoom lens 125 is driven to the predetermined position. In a case where the reference position detection of the focus lens 105 is completed, the processing of step S205 is performed; otherwise, the determination in step S206 is repeated (standby).

In the processing of steps S203, S204, and S205, the zoom lens 125 is driven to the predetermined position just after the reference position detection of the zoom lens 125 is completed. However, similarly to step S206, the zoom lens 125 may be driven to the predetermined position after waiting until the detection of the reference position of the focus lens 105 is completed. In this case, instead of waiting for the zoom lens 125 to stop, the zoom lens 125 may be driven to the predetermined position at a speed lower than the normal speed. In other words, the driving of the zoom lens 125 to the predetermined position may be delayed by waiting or driving at a speed lower than the normal speed until the detection of the reference position of the focus lens 105 is completed. In the processing from step S206 to step S205, instead of waiting for the zoom lens 125, it may be driven to the predetermined position at a low speed.

This embodiment has discussed the reset control processing for the focus lens 105 and the zoom lens 125, but similar reset control processing may be performed for the driving of the focus lens 105 and the floating lens 121, and the driving of the zoom lens 125 and the floating lens 121. In this case, the first optical element and the second optical element may be any of the focus lens 105, the floating lens 121, and the zoom lens 125. Thereby, interference between these lenses can be avoided.

In this embodiment, the zoom lens 125 is driven to the predetermined position after being driven to the reference position, but in a case where the zoom actuator does not require reference position detection, the zoom lens 125 may be driven to the predetermined position without being driven to the reference position.

In this embodiment, the reference position is detected by moving the focus lens 105 in the infinity direction while moving the zoom lens 125 in the wide-angle direction, passing through the focus reference position, and then moving it back to the focus reference position in the close distance direction. In contrast, the reference position may be detected by moving the focus lens 105 in the close distance direction while moving the zoom lens 125 in the wide-angle direction, passing through the focus reference position, and then moving it back to the focus reference position in the infinity direction. That is, in a case where the zoom lens 125 is moved in the first direction toward the predetermined position, the drive direction in the reference position drive of the focus lens 105 may not be the first direction as long as the focus reference position as the used reference position is located in the first direction from the predetermined position.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This embodiment can avoid interference between the first and second optical elements.

This application claims the benefit of Japanese Patent Application No. 2025-011969, filed on January 28, 2025, which is hereby incorporated by reference herein in its entirety.

What is claimed is:

1. A control apparatus configured to control movements of a first optical element and a second optical element in an optical axis direction, the control apparatus comprising:
one or more memories storing instructions; and
one or more processors that, upon execution of the instructions, operate to:
acquire information on a reference position of the first optical element at each of a plurality of first reference positions, at least one of the plurality of first reference positions being located within a movable range of the second optical element, and
in a specific control for moving the first optical element for detecting the reference position and moving the second optical element to a predetermined position within the movable range, change a specific reference position among the plurality of first reference positions according to the predetermined position, the specific reference position being used for the detecting.

2. The control apparatus according to claim 1, wherein when moving the second optical element to the predetermined position in a first direction in the specific control, the one or more processors operate to set the specific reference position to a first reference position among the plurality of first reference positions, which is located in the first direction from the predetermined position.

3. The control apparatus according to claim 2, wherein in a case where the predetermined position is located at an end of the movable range in the first direction in the specific control, the one or more processors operate to set the specific reference position to a first reference position among the plurality of first reference positions, which is located outside the movable range in the first direction.

4. The control apparatus according to claim 2, wherein in a case where the predetermined position is located inside an end of the movable range in the first direction in the specific control, the one or more processors operate to set the specific reference position to a first reference position that is located in the first direction from the predetermined position and within the movable range.

5. The control apparatus according to claim 4, wherein in the specific control, the one or more processors operate to set the specific reference position to a first reference position among the plurality of first reference positions, which is closest to the first optical element in the first direction from the predetermined position.

6. The control apparatus according to claim 2, wherein the first optical element is disposed in the first direction from the second optical element.

7. The control apparatus according to claim 2, wherein in the specific control, the one or more processors operate to move the first optical element to the specific reference position in the first direction and then further move the first optical element to another predetermined position in the first direction.

8. The control apparatus according to claim 1, wherein in the specific control, the one or more processors operate to delay movement of the second optical element to the predetermined position until a detection of the reference position for the first optical element is completed.

9. The control apparatus according to claim 1, wherein the one or more processors operate to:
acquire information on a reference position of the second optical element at a second reference position, and
move the second optical element to the second reference position and then move the second optical element to the predetermined position in the specific control.

10. The control apparatus according to claim 1, wherein in the specific control, the one or more processors operate to acquire information on the reference position by moving the first optical element such that the first optical element passes the specific reference position and then returns to the specific reference position at a speed lower than a speed when the first optical element passes the specific reference position.

11. The control apparatus according to claim 1, wherein each of the first optical element and the second optical element moves during at least one of focusing and zooming.

12. A control apparatus configured to control movements of a first optical element and a second optical element in an optical axis direction, the control apparatus comprising:
one or more memories storing instructions; and
one or more processors that, upon execution of the instructions, operate to:
acquire information on a reference position of the first optical element at each of a plurality of first reference positions, at least one of the plurality of first reference positions being located within a movable range of the second optical element, and
set, in a specific control for moving the first optical element for detecting the reference position and moving the second optical element to a predetermined position within the movable range, a specific reference position among the plurality of first reference positions, the specific reference position being used for the detecting, to a first reference position located outside a movement path of the second optical element to the predetermined position.

13. An optical apparatus
the first optical element and the second optical element; and
the control apparatus according to claim 1.

14. A control method configured to control movements of a first optical element and a second optical element in an optical axis direction, a reference position of the first optical element at each of a plurality of first reference positions being detectable, and at least one of the plurality of first reference positions being located within a movable range of the second optical element, the control method comprising:
acquiring information on a reference position of the first optical element at each of a plurality of first reference positions; and
in a specific control for moving the first optical element for detecting the reference position and moving the second optical element to a predetermined position within the movable range, changing a specific reference position among the plurality of first reference positions according to the predetermined position, the specific reference position being used for the detecting.

15. A non-transitory computer-readable storage medium storing a program that causes a computer to execute the control method according to claim 14.
